(19) United States
(12) Patent Application Publication
(10) Pub. No.: US 2026/0363028 A1
(43) Pub. Date: Nov. 12, 2026

(54) METHOD FOR CONTROLLING SEMICONDUCTOR PROCESS

(71) Applicant: SAMSUNG ELECTRONICS CO., LTD., Suwon-si (KR)

(72) Inventors: Minhwan LEE, Suwon-si (KR); Sungjin KIM, Suwon-si (KR); Yuyeol LEE, Suwon-si (KR); Juho LEE, Suwon-si (KR); Sungduk HONG, Suwon-si (KR)

(73) Assignee: SAMSUNG ELECTRONICS CO., LTD., Suwon-si (KR)

(21) Appl. No.: 19/410,512

(22) Filed: Dec. 5, 2025

(30) Foreign Application Priority Data
May 7, 2025 (KR) 10-2025-0059164

(51) Int. Cl. H10P 74/00; G06F 30/27; G06F 119/18

(52) U.S. Cl. CPC H10P 74/23; G06F 30/27; G06F 2119/18

(57) ABSTRACT

A method for controlling a semiconductor process includes using a technology computer aided design (TCAD) simulation tool receiving a plurality of simulation parameters to output a predicted characteristic curve of an element, and a machine-learning model receiving a plurality of measured characteristic curves, measured from a wafer to predict the plurality of simulation parameters, to generate raw data including solutions for the plurality of simulation parameters; calculating an average and a standard deviation for each of the simulation parameters based on the raw data to generate statistical data; selecting at least one simulation parameter among the plurality of simulation parameters using the statistical data; and monitoring a process related to the at least one simulation parameter.

### CROSS-REFERENCE TO RELATED APPLICATION.S

This application claims benefit of priority to Korean Patent Application No. 10-2025-0059164 filed on May. 7, 2025 in the Korean Intellectual Property Office, the disclosure of which is incorporated herein by reference in its entirety.

### BACKGROUND

The present disclosure relates to a method for controlling a semiconductor process.

A technology computer aided design (TCAD) simulation tool may be a tool for receiving various parameters to predict characteristics of an element, and recently, a tool for predicting parameters inversely from a characteristic curve of an element using a machine-learning model is also being developed. A tool capable of performing a semiconductor process to actually measure a characteristic curve from an element formed on a wafer, and of extracting simulation parameters that may reproduce the measured characteristic curve, may be implemented with a machine-learning model. However, a tool based on a machine-learning model extracting simulation parameters from a characteristic curve may have multiple solutions due to a multivariable function optimization problem, and thus, there may be a problem that it is difficult to utilize the extracted simulation parameters for statistical analysis and for predicting defects in a semiconductor component or device.

### SUMMARY

One of a number of problems to be addressed by the technical idea of the present disclosure is to provide a method for controlling a semiconductor process, which may estimate a cause of characteristic changes between wafers by inputting characteristic curves, measured from an element, into a tool based on a machine-learning model to extract simulation parameters, and comparing and analyzing the extracted simulation parameters through statistical analysis.

According to an aspect of the disclosure, a method for controlling a semiconductor process, including: obtaining a plurality of candidate values for a plurality simulation parameters of a plurality of first elements included in a first wafer and a plurality of second elements included in a second wafer by inputting a plurality of measured characteristic curves, measured from each of the plurality of first elements and each of the plurality of second elements, into a machine-learning model a plurality of times; obtaining a plurality of predicted characteristic curves based on the plurality of candidate values for each of the plurality of first elements and each of the plurality of second elements; determining a selection characteristic curve having a lowest error rate among the plurality of predicted characteristic curves by comparing the predicted plurality of characteristic curves with the plurality of measured characteristic curves; selecting, among the plurality of candidate values, a candidate value matching the selection characteristic curve as a determination value for the plurality of simulation parameters; calculating a first average and a first standard deviation with determination values selected for the plurality of first elements, and calculating a second average and a second standard deviation with determination values selected for the plurality of second elements; and applying statistical analysis to the first average, the second average, the first standard deviation, and the second standard deviation, to determine a difference in the plurality of simulation parameters.

According to an aspect of the disclosure, a method for controlling a semiconductor process includes: obtaining a plurality of first measured characteristic curves by inserting a first wafer into measurement equipment; obtaining, by using the plurality of first measured characteristic curves, first raw data comprising a plurality of first solutions for simulation parameters, which are input variables of a technology computer aided design (TCAD) simulation tool; obtaining a plurality of second measured characteristic curves by inserting a second wafer, different from the first wafer, into the measurement equipment; obtaining, by using the plurality of second measured characteristic curves, second raw data including a plurality of second solutions for the simulation parameters, which are the input variables of the TCAD simulation tool; generating first statistical data by calculating an average and a standard deviation for each of the simulation parameters from the first raw data; generating second statistical data by calculating an average and a standard deviation for each of the simulation parameters from the second raw data; and inputting the first statistical data and the second statistical data into a statistical analysis program to determine whether a difference of each of the simulation parameters is absent or present, and a magnitude of the difference.

According to an aspect of the disclosure, a method for controlling a semiconductor process includes using a technology computer aided design (TCAD) simulation tool receiving a plurality of simulation parameters to output a predicted characteristic curve of an element, and a machine-learning model receiving a plurality of measured characteristic curves, measured from a wafer to predict the plurality of simulation parameters, to generate raw data including solutions for the plurality of simulation parameters; calculating an average and a standard deviation for each of the simulation parameters based on the raw data to generate statistical data; selecting at least one simulation parameter among the plurality of simulation parameters using the statistical data; and monitoring a process related to the at least one simulation parameter.

A device for controlling a semiconductor process, according to one or more embodiments, may include a memory configured to store a machine-learning model receiving measured characteristic curves obtained by measuring wafers by measurement equipment to predict simulation parameters, and a TCAD simulation tool receiving the simulation parameters to output a predicted characteristic curve of a transistor, and a processor configured to determine at least one simulation parameter related to a characteristic difference between the wafers among the simulation parameters by using the machine-learning model and the TCAD simulation tool.

In a device for controlling a semiconductor process, according to an example embodiment, the processor may monitor a semiconductor process related to the at least one simulation parameter, and may adjust a process variable of process equipment performing the semiconductor process.

### BRIEF DESCRIPTION OF DRAWINGS

The and other aspects, features, and advantages of the present disclosure will be more clearly understood from the following detailed description, taken in conjunction with the accompanying drawings, in which:

FIGS. 1 and 2 are views simply illustrating tools applied to a method for controlling a semiconductor process according to one or more embodiments.

FIG. 3 is a view illustrating a system in which a method for controlling a semiconductor process according to one or more embodiments is executed.

FIGS. 4 to 6 are flowcharts illustrating a method for controlling a semiconductor process according to one or more embodiments.

FIG. 7 is a view simply illustrating a semiconductor device according to one or more embodiments.

FIGS. 8 and 9 are views simply illustrating wafers to which a method for controlling a semiconductor process according to one or more embodiments is applied.

FIGS. 10 to 13 are views illustrating a method for controlling a semiconductor process according to one or more embodiments.

FIGS. 14 and 15 are views illustrating a method for controlling a semiconductor process according to one or more embodiments.

FIG. 16 is a block diagram of an example computer system, in accordance with embodiments of the present disclosure.

### DETAILED DESCRIPTION

Hereinafter, preferred embodiments will be described with reference to the attached drawings.

Various modifications may be made to the embodiments of the disclosure, and there may be various types of embodiments. Accordingly, specific embodiments will be illustrated in drawings, and the embodiments will be described in detail in the detailed description. However, it should be noted that the various embodiments are not for limiting the scope of the disclosure to a specific embodiment, but they should be interpreted to include various modifications, equivalents, and/or alternatives of the embodiments of the disclosure. Also, with respect to the detailed description of the drawings, similar components may be designated by similar reference numerals.

Also, in describing the disclosure, in case it is determined that detailed explanation of related known functions or features may unnecessarily confuse the gist of the disclosure, the detailed explanation will be omitted.

In addition, the embodiments described below may be modified in various different forms, and the scope of the technical idea of the disclosure is not limited to the embodiments below. Rather, these embodiments are provided to make the disclosure more sufficient and complete, and to fully convey the technical idea of the disclosure to those skilled in the art.

Also, the terms used in the disclosure are used only to explain specific embodiments, and are not intended to limit the scope of the disclosure. Further, singular expressions include plural expressions, unless defined obviously differently in the context.

In addition, in the disclosure, expressions such as “have,” “may have,” “include,” and “may include” denote the existence of such characteristics (e.g.: elements such as numbers, functions, operations, and components), and do not exclude the existence of additional characteristics.

Also, in the disclosure, the expressions “A or B,” “at least one of A and B,” “at least one of A or B,” or “one or more of A and/or B” and the like may include all possible combinations of the listed items. For example, “A or B,” “at least one of A and B,” or “at least one of A or B” may refer to all of the following cases: (1) including A, (2) including B, or (3) including A and B.

In addition, the expressions “first,” “second,” and the like used in the disclosure may describe various elements regardless of any order and/or degree of importance. Also, such expressions are used only to distinguish one element from another element, and are not intended to limit the elements.

Meanwhile, the description in the disclosure that one element (e.g.: a first element) is “(operatively or communicatively) coupled with/to” or “connected to” another element (e.g.: a second element) should be interpreted to include both the case where the one element is directly coupled to the another element, and the case where the one element is coupled to the another element through still another element (e.g.: a third element).

In contrast, the description that one element (e.g.: a first element) is “directly coupled” or “directly connected” to another element (e.g.: a second element) can be interpreted to mean that still another element (e.g.: a third element) does not exist between the one element and the another element.

Also, the expression “configured to” used in the disclosure may be interchangeably used with other expressions such as “suitable for,” “having the capacity to,” “designed to,” “adapted to,” “made to,” and “capable of,” depending on cases. Meanwhile, the term “configured to” may not necessarily mean that an apparatus is “specifically designed to” in terms of hardware.

Instead, under some circumstances, the expression “an apparatus configured to” may mean that the apparatus “is capable of” performing an operation together with another apparatus or component. For example, the phrase “a processor configured to perform A, B, and C” may mean a dedicated processor (e.g.: an embedded processor) for performing the corresponding operations, or a generic-purpose processor (e.g.: a CPU or an application processor) that can perform the corresponding operations by executing one or more software programs stored in a memory device.

Further, in the embodiments of the disclosure, ‘a module’ or ‘a part’ may perform at least one function or operation, and may be implemented as hardware or software, or as a combination of hardware and software. Also, a plurality of ‘modules’ or ‘parts’ may be integrated into at least one module and implemented as at least one processor, excluding ‘a module’ or ‘a part’ that needs to be implemented as specific hardware.

Meanwhile, various elements and areas in the drawings were illustrated schematically. Accordingly, the technical idea of the disclosure is not limited by the relative sizes or intervals illustrated in the accompanying drawings.

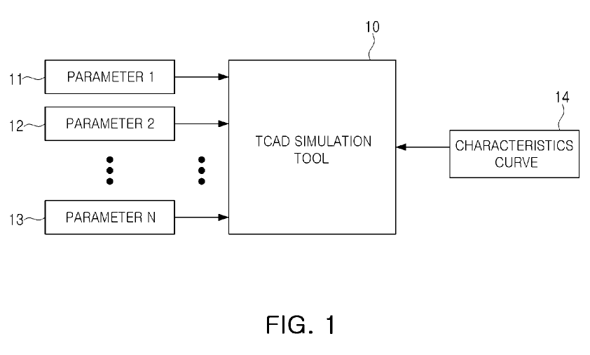

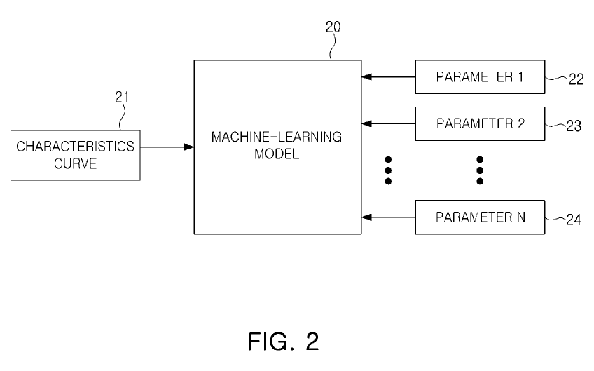

FIGS. 1 and 2 are views simply illustrating tools applied to a method for controlling a semiconductor process according to one or more embodiments.

Referring to FIGS. 1 and 2, a technology computer aided design (TCAD) simulation tool 10 and a machine-learning model 20 may be used in a method for controlling a semiconductor process according to one or more embodiments. The TCAD simulation tool 10 may receive a plurality of parameters 11 to 13, as disclosed in FIG. 1, and may output a characteristic curve 14. The plurality of parameters 11 to 13 input to the TCAD simulation tool 10 may be simulation parameters, and the characteristic curve 14 may be a curve representing characteristics of a semiconductor device.

For example, the characteristic curve 14 may be a curve representing a voltage-current relationship of a semiconductor device, and may represent, for example, a gate voltage-drain current relationship of a transistor. The plurality of parameters 11 to 13 may include various parameters affecting a structure and characteristics of the semiconductor device, and may include, for example, a structural parameter, a process parameter, or the like. When the semiconductor device is a transistor, the plurality of parameters 11 to 13 may include, for example, a thickness of a gate-insulating layer, a length of a gate, a thickness of a channel, a doping concentration of the channel, process conditions of semiconductor processes for manufacturing the transistor, or the like.

The machine-learning model 20 may be trained to receive, in reverse, a characteristic curve 21 of the semiconductor device, and output predicted values for a plurality of parameters 22 to 24. For example, when a characteristic curve 21 defining a relationship between gate voltage and drain current of the transistor is input into the machine-learning model 20 of which learning has been completed, the machine-learning model 20 may output predicted values for the thickness of the gate insulating layer, the length of the gate, the thickness of the channel, the doping concentration of the channel, the process conditions of the semiconductor processes for manufacturing the transistor, or the like.

In one or more embodiments, a method for predicting a cause of a characteristic difference appearing in semiconductor devices formed on each of different wafers may be proposed using the TCAD simulation tool 10 and the machine-learning model 20. In one or more embodiments, yield and reliability of the semiconductor process may be improved by accurately predicting the cause causing the characteristic difference between the semiconductor devices included in each of the wafers, and monitoring and controlling the semiconductor process affecting the predicted cause.

For example, a characteristic curve may be measured for each of a plurality of semiconductor devices included in a first wafer. The semiconductor device actually measuring the characteristic curve may be the transistor, and the characteristic curve may be a gate voltage-drain current curve. However, the embodiments are not limited to these configurations. When the characteristic curve is actually measured, candidate values for the plurality of parameters 22 to 24 may be obtained by inputting a measured characteristic curve into the machine-learning model 20.

A task of extracting the plurality of parameters 22 to 24from one measured characteristic curve may include a multivariable function optimization task optimizing the plurality of parameters 22 to 24, and therefore, may generally have a multi-solution issue in which two or more solutions are derived. In one or more embodiments, by inputting one measured characteristic curve measured from one semiconductor device into the machine- learning model 20, a plurality of candidate solutions in which candidate values for each of the plurality of parameters 22 to 24 are combined may be obtained.

One candidate solution may have one candidate value for each of the plurality of parameters 22 to 24, and different candidate solutions may have different candidate values for at least one of the plurality of parameters 22 to 24. For example, a first candidate solution and a second candidate solution, derived from one measured characteristic curve measured from one semiconductor device, may have candidate values for the plurality of parameters 22 to 24, respectively. As an example, a candidate value produced for a first parameter 22 in the first candidate solution may be different from a candidate value produced for the first parameter 22 in the second candidate solution. In this case, a candidate value produced for a second parameter 23 in the first candidate solution may be the same as a candidate value produced for the second parameter 23 in the second candidate solution.

Each of the plurality of candidate solutions produced from one measured characteristic curve may be input into the TCAD simulation tool 10. For example, values of the plurality of parameters 11 to 13, which may be input data of the TCAD simulation tool 10, may be determined by candidate values produced for the plurality of parameters 22 to 24 in the first candidate solution. The TCAD simulation tool 10 may receive each of the plurality of candidate solutions, and may output predicted characteristic curves estimating the characteristic curve 14 of the semiconductor device, based on each of the candidate solutions.

Through the process, a plurality of predicted characteristic curves may be produced from one measured characteristic curve. The plurality of predicted characteristic curves may be compared with the measured characteristic curve, and one selection characteristic curve having the lowest error rate, compared with the measured characteristic curve, may be determined among the plurality of predicted characteristic curves.

A task, as described above, may be performed on each of the predicted characteristic curves measured from the plurality of semiconductor devices formed on the first wafer, to determine one selection characteristic curve for each of the plurality of semiconductor devices formed on the first wafer, and one selection solution input to the TCAD simulation tool 10 in which the one selection characteristic curve is produced. A selection solution may be selected from among the plurality of candidate solutions. Therefore, a plurality of selection solutions corresponding to the plurality of semiconductor devices included in the first wafer may be obtained. For example, the number of the plurality of selection solutions may be equal to the number of the plurality of semiconductor devices of which measured characteristic curves are measured.

When the plurality of selection solutions are determined, an average and a standard deviation of each of the plurality of parameters 11 to 13, and 22 to 24 may be calculated. A task, as described above, may be performed in the same manner on the second wafer, different from the first wafer, to obtain a plurality of selection solutions for the plurality of semiconductor devices included in the second wafer, and calculate the average and the standard deviation of each of the plurality of parameters 11 to 13, and 22 to 24. Thereafter, the average and the standard deviation of each of the plurality of parameters 11 to 13, and 22 to 24 obtained using the first wafer may be compared with the average and the standard deviation of each of the plurality of parameters 11 to 13, and 22 to 24 obtained using the second wafer. Based on the comparison results, a cause causing a difference in characteristics between the plurality of semiconductor devices included in the first wafer and the plurality of semiconductor devices included in the second wafer may be estimated or predicted, and the semiconductor process may be monitored and controlled, based on the estimation results. For example, based on the estimated or predicted cause, one or more semiconductor processes may be controlled or adjusted. For example, during manufacturing of a semiconductor wafer, an etching process may be adjusted to prevent a defect from occurring. In one or more examples, after a semiconductor wafer is manufactured, based on the estimated or predicted cause, a corrective process may be performed on the semiconductor wafer to cure a defect.

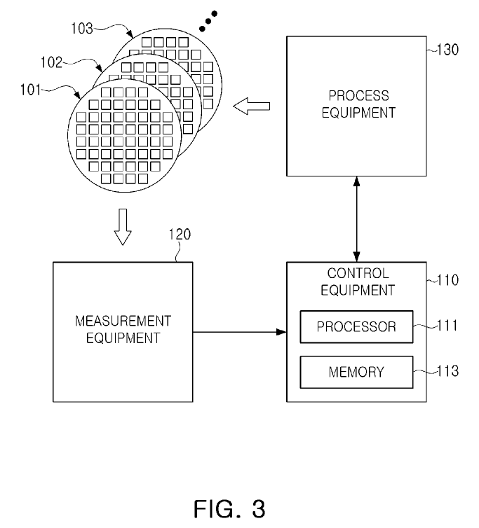

FIG. 3 is a view illustrating a system in which a method for controlling a semiconductor process according to one or more embodiments is executed.

Referring to FIG. 3, a system 100 according to one or more embodiments may include control equipment 110, measurement equipment 120, process equipment 130, and the like. The process equipment 130 may include devices performing a semiconductor process, such as a photolithography process, an etching process, a deposition process, a polishing process, a cleaning process, or the like, on each of a plurality of wafers 101 to 103. The measurement equipment 120 may perform a measurement task on the plurality of wafers 101 to 103 having undergone the semiconductor process in the process equipment 130.

For example, the measurement equipment 120 may perform a measurement task for measuring electrical characteristics of a plurality of elements formed on the plurality of wafers 101 to 103 by the semiconductor process. The measurement equipment 120 may be equipped with a function of measuring a characteristic curve indicating a relationship between a gate voltage and a drain current in a transistor formed on each of the plurality of wafers 101 to 103.

The control equipment 110 may control an overall operation of the system 100. For example, the control equipment 110 may control the process equipment 130 to perform a semiconductor process on the plurality of wafers 101 to 103. The control equipment 110 may receive measurement data obtained by the measurement equipment 120 performing a measurement operation on the plurality of wafers 101 to 103, and may control the process equipment 130 by referring to the measurement data.

The control equipment 110 may include a processor 111 and a memory 113. According to one or more embodiments, the control equipment 110 may further include a communication interface for communicating with the measurement equipment 120 and the process equipment 130, a sensor for monitoring a surrounding environment, an input/output interface for receiving input from an operator and outputting information to the operator, or the like.

The memory 113 of the control equipment 110 may store a machine-learning model, a TCAD simulation tool, a statistical analysis program, or the like. The machine-learning model stored in the memory 113 may be a model trained to receive a measured characteristic curve measured by the measurement equipment 120 from at least one transistor among the plurality of wafers 101 to 103, and output simulation parameters corresponding to the received measured characteristic curve.

The simulation parameters may be parameters matching the measured characteristic curve obtained by the measurement equipment 120 from the at least one transistor among the plurality of wafers 101 to 103, and for example, the simulation parameters may be input into the TCAD simulation tool to obtain a characteristic curve of the transistor. A task of extracting simulation parameters from one measured characteristic curve may include a multivariable function optimization task, and thus may have a multi-solution issue.

In one or more embodiments, the processor 111 may input one measured characteristic curve obtained from one transistor into the machine-learning model multiple times, to obtain a plurality of candidate solutions, which may be sets of candidate values for the simulation parameters. The processor 111 may input the plurality of candidate solutions into the TCAD simulation tool, to obtain a plurality of predicted characteristic curves. For example, the number of the plurality of candidate solutions may be equal to the number of the plurality of predicted characteristic curves.

The processor 111 may compare each of the plurality of predicted characteristic curves with the measured characteristic curve received from the measurement equipment 120, to determine a selection characteristic curve from among the plurality of predicted characteristic curves, and to determine a selection solution matching the selection characteristic curve from among the plurality of candidate solutions. The processor 111 may apply the process to the measured characteristic curves obtained by measuring the transistors of the first wafer 101 by the measurement equipment 120, to obtain a plurality of first selection solutions. Similarly, the processor 111 may apply the process to the measured characteristic curves obtained from the transistors of each of the second wafer 102 and the third wafer 103, to obtain a plurality of second selection solutions and a plurality of third selection solutions.

The processor 111 may produce technical statistics, extraction deviations, or the like of the plurality of first selection solutions. For example, the technical statistics may include an average and a standard deviation of each of the simulation parameters produced from the plurality of first selection solutions. The extraction deviation may be a variable indicating how large the multi-solution issue is in each of the simulation parameters. For example, the extraction deviation may be determined from the standard deviation calculated for each of the simulation parameters by using the plurality of candidate solutions obtained by inputting the measured characteristic curve obtained from one transistor into the machine-learning model multiple times. The processor 111 may calculate an average and a standard deviation of each of the simulation parameters using the plurality of second selection solutions, and may calculate an average and a standard deviation of each of the simulation parameters using the plurality of third selection solutions.

The processor 111 may determine a significant difference of each of the simulation parameters by inputting an average and a standard deviation calculated for each of the simulation parameters into a statistical analysis program. For example, the plurality of wafers 101 to 103 may be sequentially input into the same process equipment 130, and nevertheless, a characteristic difference may appear in a transistor of a first wafer 101, a transistor of a second wafer 102, and a transistor of a third wafer 103. The significant difference in each of the simulation parameters may represent a major variable of the characteristic difference appearing between the wafers 101 to 103, as described above.

For example, the simulation parameters may include a thickness of a gate insulating layer and a doping concentration of an active region. When a significant difference produced from the thickness of the gate insulating layer is relatively large, as compared to a significant difference produced from the doping concentration of the active region, it may be determined that the characteristic difference appearing in the transistors formed on the wafers 101 to 103 is more greatly affected by a process of forming the gate insulating layer. Therefore, the control equipment 110 may monitor the process of forming the gate insulating layer performed in the process equipment 130 and, as necessary, may adjust process variables applied to the process of forming the gate insulating layer, thereby reducing a characteristic deviation of the transistors included in the wafers 101 to 103. In or more examples, a significant difference may be determined when a difference between a predicted characteristic and a measured characteristic is more than one standard deviation or is greater than a predetermined threshold.

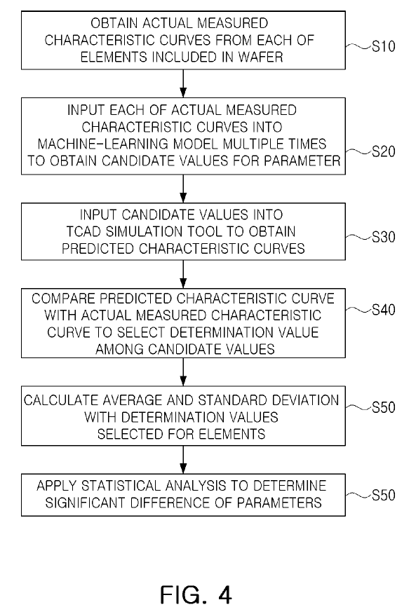

FIGS. 4 to 6 are flowcharts illustrating a method for controlling a semiconductor process according to one or more embodiments.

Referring to FIG. 4, a method for controlling a semiconductor process according to one or more embodiments may begin with obtaining measured characteristic curves from each of elements included in a wafer (S10). For example, a measured characteristic curve may be a voltage-current curve of a transistor, and may include a gate voltage-drain current curve, a drain voltage-drain current curve, or the like. The measured characteristic curve may be measured by measurement equipment.

The measured characteristic curves may be input to a pre-trained machine-learning model. The machine-learning model may be trained to receive the measured characteristic curve, such as the voltage-current curve, and to output candidate values for a parameter. The parameter may be one of simulation parameters corresponding to an input variable of a TCAD simulation tool. For example, when an element from which the measured characteristic curve is obtained is a DRAM memory cell implementing a channel with an indium gallium zinc oxide (IGZO) material, the parameter may be one of a thickness of a gate insulating layer, a length of a gate, a doping concentration of an IGZO channel, or a thickness of the IGZO channel. For example, each of the measured characteristic curves may be input into the machine-learning model multiple times to obtain a plurality of candidate values for one parameter (S20).

The plurality of candidate values obtained for the parameter may be input into the TCAD simulation tool. The TCAD simulation tool may output a predicted characteristic curve as a response to each of the plurality of candidate values. Therefore, the plurality of candidate values may be input into the TCAD simulation tool to obtain a plurality of predicted characteristic curves corresponding to the plurality of candidate values (S30).

The plurality of predicted characteristic curves may be compared with the measured characteristic curve. For example, the measured characteristic curve compared with the plurality of predicted characteristic curves may be distinguished, depending on an element. Assuming that a first measured characteristic curve is obtained for a first element and a second measured characteristic curve is obtained for a second element in S10, the first measured characteristic curve may be input into the machine-learning model multiple times to obtain a plurality of first candidate values, and the second measured characteristic curve may be input into the machine-learning model multiple times to obtain a plurality of second candidate values. Thereafter, the plurality of first candidate values may be input into the TCAD simulation tool to obtain a plurality of first predicted characteristic curves for the first element, and the plurality of second candidate values may be input into the TCAD simulation tool to obtain a plurality of second predicted characteristic curves for the second element.

Each of the plurality of first predicted characteristic curves may be compared with the first measured characteristic curve, and each of the plurality of second predicted characteristic curves may be compared with the second measured characteristic curve. As a result of the comparison, one first predicted characteristic curve, most similar to the first measured characteristic curve, may be determined as a first selection characteristic curve, and one second predicted characteristic curve, most similar to the second measured characteristic curve, may be determined as a second selection characteristic curve. One first candidate value input into the TCAD simulation tool output the first selection characteristic curve may be selected as a first determination value among the plurality of first candidate values, and one second candidate value input into the TCAD simulation tool output the second selection characteristic curve may be selected as a second determination value among the plurality of second candidate values. In one or more examples, the similarity between curves may be determined using any suitable comparison method including, but not limited to, Dynamic Time warping (DTW), Fréchet distance, or area-based measures.

Through a process, as described above, one determination value among the plurality of candidate values may be selected for each of the plurality of elements (S40). Therefore, a plurality of determination values may be produced for one parameter from a plurality of elements included in one wafer, and an average and a standard deviation for the parameter may be calculated with the plurality of determination values (S50).

The average and the standard deviation produced for the parameter may be applied to statistical analysis. The statistical analysis may be applied to the average and the standard deviation to determine a significant difference of a parameter corresponding thereto (S60). For example, the operations S10 to S50, described above, may be applied to a plurality of wafers to calculate an average and a standard deviation for a specific parameter in each of the wafers, and the statistical analysis may be applied to determine the significant difference of the parameter corresponding thereto.

For example, when the significant difference is large, it may be interpreted that the parameter corresponding thereto is related to a characteristic difference between wafers, and has a great influence on the characteristic difference between the wafers. Therefore, a process affecting the parameter corresponding thereto may be intensively monitored, and, when necessary, process variables may be adjusted to reduce the characteristic difference between the wafers and to improve yield of the process. For example, when the significant difference is greater than a predetermined reference value, the process affecting the parameter corresponding thereto may be monitored, and the process variables may be adjusted.

The method according to one or more embodiments described with reference to FIG. 4 may be executed in control equipment controlling the semiconductor process. For example, after the semiconductor process is performed on the wafers, and a plurality of elements are formed on each of the wafers, each of the wafers may be fed into measurement equipment to obtain the measured characteristic curves described in S10. Thereafter, the machine-learning model, the TCAD simulation tool, and the statistical analysis program stored in the memory or the like in the control equipment may be used to determine the significant differences in the parameter.

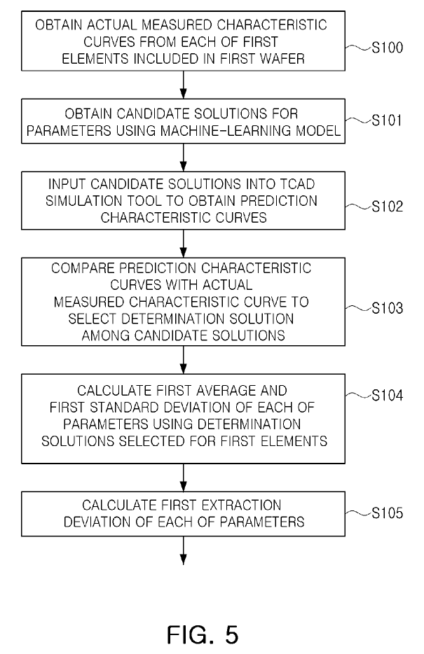

Next, referring to FIG. 5, a method for controlling a semiconductor process according to one or more embodiments may begin with obtaining measured characteristic curves from each of first elements included in a first wafer (S100). The first elements may be elements formed at different positions on the first wafer, and for example, elements included in different dies among a plurality of semiconductor dies included in the first wafer may be selected as the first elements. For example, a measured characteristic curve may be a voltage-current curve of a first element.

When the measured characteristic curve is obtained for each of the first elements, the measured characteristic curve may be input into a machine-learning model to obtain candidate solutions for parameters (S101). In S101, one measured characteristic curve obtained by measuring characteristics of one first element may be input into the machine-learning model multiple times. Therefore, for one measured characteristic curve, a plurality of candidate solutions for parameters may be obtained. The parameters may be simulation parameters, which may be input variables of a TCAD simulation tool.

The candidate solutions obtained in S101 may be input into the TCAD simulation tool, and the TCAD simulation tool may output prediction characteristic curves corresponding to the candidate solutions (S102). Therefore, the number of prediction characteristic curves equal to the number of candidate solutions may be obtained in S102.

The prediction characteristic curves may be compared with the measured characteristic curves obtained in S100. One measured characteristic curve obtained for one first element may be input into the machine-learning model multiple times, to obtain a plurality of candidate solutions, and the plurality of candidate solutions may be input into the TCAD simulation tool, to obtain a plurality of prediction characteristic curves. Therefore, a plurality of prediction characteristic curves corresponding to one first element may be compared with one measured characteristic curve measured from the same first element.

Based on the comparison results, one prediction characteristic curve most similar to the measured characteristic curve may be selected from among the plurality of prediction characteristic curves. In addition, one candidate solution corresponding to the selected prediction characteristic curve may be selected as a determination solution among the plurality of candidate solutions (S103). Therefore, one determination solution may be selected for one first element.

By the task described with reference to S100 to S103, determination solutions for first elements included in the first wafer may be generated. The determination solutions may be generated for a plurality of parameters, and for example, for one parameter, there may be a plurality of determination values for the first elements. Thereafter, using the determination solutions generated for the first elements, a first average and a first standard deviation of each of the parameters may be calculated (S104), and a first extraction deviation of each of the parameters may be calculated (S105).

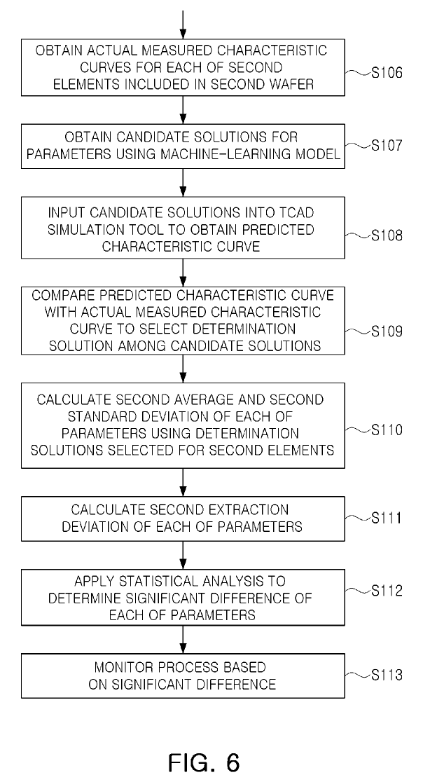

Next, referring to FIG. 6, a similar task may be performed for second elements included in a second wafer, which may be different from a first wafer. First, the second wafer may be input into measurement equipment to obtain measured characteristic curves for each of the second elements included in the second wafer (S106). Afterwards, the measured characteristic curves may be input into a machine-learning model to obtain candidate solutions for parameters (S107). As described above, one measured characteristic curve obtained for one second element may be input into the machine-learning model multiple times, to obtain candidate solutions for parameters.

The candidate solutions may be input into a TCAD simulation tool, and the TCAD simulation tool may output a predicted characteristic curve for each of the candidate solutions. Therefore, for one second element, a plurality of predicted characteristic curves matching a plurality of candidate solutions may be obtained (S108). The predicted characteristic curves obtained for one second element may be compared with the measured characteristic curve of the corresponding second element, and as a result of the comparison, one predicted characteristic curve most similar to the measured characteristic curve and one determination solution matching the predicted characteristic curve may be selected (S109). The determination solution may be selected from among the plurality of candidate solutions.

In a similar manner to a task on the first wafer, tasks of S106 to S109 for each of a plurality of second elements included in the second wafer may be executed to generate determination solutions for the second elements. The determination solutions may be generated for a plurality of parameters, and for example, for one parameter, there may be a plurality of determination values for the second elements. Thereafter, using the determination solutions generated for the second elements, a second average and a second standard deviation of each of the parameters may be calculated (S110), and a second extraction deviation of each of the parameters may be calculated (S111).

Tasks of S100 to S111 may be executed in control equipment linked to the measurement equipment performing a measurement operation on the first wafer and the second wafer, to obtain a measured characteristic curve. In one or more embodiments, the control equipment may include a processor and a memory, and the memory may store a machine-learning model and a TCAD simulation tool, necessary for executing the tasks of S100 to S111.

A statistical analysis program may be further stored in the memory, and the processor may apply the statistical analysis program to a first average, a first standard deviation, a second average, and a second standard deviation, to determine a significant difference of each of the parameters (S112). The significant difference of each of the parameters may be a concept indicating a degree to which a parameter corresponding thereto affects a characteristic difference between the first elements included in the first wafer and the second elements included in the second wafer.

For example, the significant difference of each of the parameters may be determined by comparing the first average and the second average, and comparing the first standard deviation and the second standard deviation. For example, as a difference between the first average and the second average relatively increases, a significant difference of a parameter corresponding thereto may be produced, and as the first standard deviation and the second standard deviation decrease, a large significant difference of a parameter corresponding thereto may be produced. As the difference between the first average and the second average relatively decreases, and the first standard deviation and the second standard deviation increase, a small significant difference of a parameter corresponding thereto may be produced.

In one or more embodiments, based on the first extraction deviation determined in S105 and the second extraction deviation determined in S111, the processor may determine a weight for determining the significant difference of each of the parameters, or may determine whether a significant difference of each of the parameters is absent or present. For example, the first extraction deviation and the second extraction deviation may indicate a degree of a multi-solution issue of a parameter corresponding thereto. For example, as distribution of candidate values obtained for a specific parameter by inputting one measured characteristic curve into the machine-learning model is widen, a large extraction deviation for a parameter corresponding thereto may be calculated. A parameter with a large extraction deviation may be determined to have no significant difference.

The control equipment may monitor a process based on the significant difference of each of parameters determined in S112 (S113). For example, assuming that the first elements and the second elements are a DRAM memory cell including an IGZO channel, respectively, the parameters may include a thickness of the IGZO channel, a thickness of a gate insulating layer, a length of a gate, or the like. Assuming that a significant difference produced for the thickness of the IGZO channel is larger than a significant difference produced for the thickness of the gate insulating layer, it may be determined that the thickness of the IGZO channel has a greater effect on a difference in characteristics of the DRAM memory cell than the thickness of the gate insulating layer. Therefore, the control equipment may monitor a process of forming the IGZO channel and, as necessary, adjust process variables controlling the process of forming the IGZO channel.

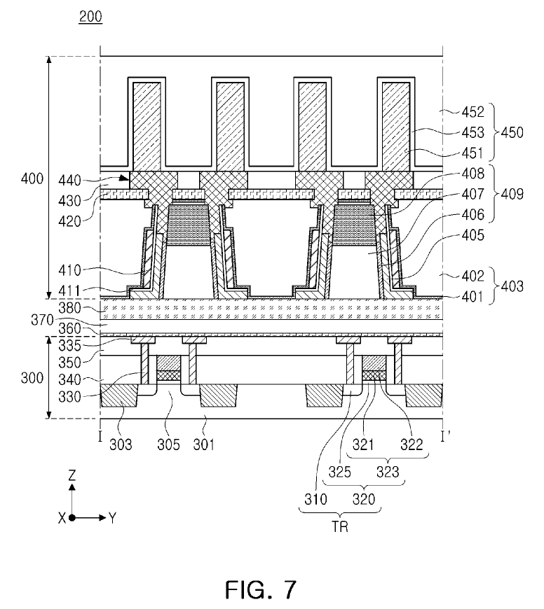

FIG. 7 is a view simply illustrating a semiconductor device according to one or more embodiments.

Referring to FIG. 7, a semiconductor device 200 according to one or more embodiments may be a DRAM device in which each of memory cells may include an IGZO channel. The semiconductor device 200 may include a lower structure 300 on which peripheral circuits such as a row decoder, a column decoder, a word line driver, a sense amplifier, and the like are disposed, and an upper structure 400 on which a plurality of memory cells are disposed, and the lower structure 300 and the upper structure 400 may be stacked in a first direction (Z-axis direction).

The lower structure 300 may include a substrate 301, a plurality of circuit elements TR, a peripheral contact 330, a peripheral interconnection 335, peripheral insulating layers 340 and 350, and the like. The substrate 301 may include a semiconductor material, for example, a group IV semiconductor, a group III-V compound semiconductor, or a group II-VI compound semiconductor. For example, the group IV semiconductor may include silicon, germanium, or silicon-germanium. The substrate 301 may be a silicon substrate, a silicon-on-insulator (SOI) substrate, a germanium substrate, a germanium-on-insulator (GOI) substrate, a silicon-germanium substrate, or a substrate including an epitaxial layer.

The plurality of circuit elements TR may include transistors. For example, a peripheral transistor may include a gate structure 320 disposed on an active region 305 separated by an element isolation film 303 in the substrate 301, and source/drain regions 310 disposed on both sides of the gate structure 320. The gate structure 320 may include a peripheral gate electrode 323 and a peripheral gate-insulating layer 325. According to one or more embodiments, the peripheral gate electrode 323 may include a first peripheral gate electrode 321 and a second peripheral gate electrode 322, stacked in the first direction.

The peripheral contact 330 may be connected to the source/drain regions 310, and may extend in the first direction, and the peripheral interconnection 335 may be electrically connected to the peripheral contact 330. The peripheral interconnection 335 may be electrically connected to the circuit element TR through the peripheral contact 330. A first peripheral insulating layer 340 may surround a side surface of the peripheral gate electrode 323 and a side surface of the peripheral contact 330. A second peripheral insulating layer 350 may be disposed on the first peripheral insulating layer 340, and in one or more embodiments, an upper surface of the second peripheral insulating layer 350 may be located at substantially the same height as an upper surface of the peripheral interconnection 335.

The first peripheral insulating layer 340 and the second peripheral insulating layer 350 may include silicon oxide, silicon nitride, silicon oxynitride, a low-κ dielectric, or a combination thereof. An etching stop layer 360 may be disposed on the lower structure 300. The etching stop layer 360 may cover the peripheral interconnection 335 and the second peripheral insulating layer 350, and may include SiBN, SiCN, SiN, or a combination thereof.

A bit line structure 380 may be disposed on the lower structure 300. The bit line structure 380 may extend in a second direction (Y-axis direction), and a plurality of bit line structures may be arranged in a third direction (X-axis direction). The bit line structure 380 may be surrounded by a bit line-insulating layer 370.

The upper structure 400 may be disposed on the bit line structure 380. The upper structure 400 may include an upper insulating layer 403, a channel structure 405, a mold structure 409, a word line structure 410, an upper capping layer 420, a landing pad 440, a capacitor structure 450, and the like.

The mold structure 409 may be disposed on the bit line structure 380. In a plan view, mold structures 409 may extend in the third direction, and may be separated from each other in the second direction. The mold structure 409 may include a first mold layer 407, a second mold layer 408, a liner 406, and the like. The second mold layer 408 may be disposed on the first mold layer 407, and the liner 406 may cover a portion of a side surface of the second mold layer 408 and a side surface of the first mold layer 407. In the first direction, an upper surface of the liner 406 may be located at a level, higher than an upper surface of the first mold layer 407, and may be located at a level, lower than an upper surface of the second mold layer 408.

The first mold layer 407 and the second mold layer 408 may include silicon oxide, silicon nitride, silicon oxynitride, or a combination thereof, respectively. In one or more embodiments, the first mold layer 407 and the second mold layer 408 may include different materials. The liner 406 may include silicon oxide, silicon oxynitride, hafnium oxide, or a combination thereof.

The channel structure 405 may be disposed on the bit line structure 380. The channel structure 405 may include a horizontal channel region contacting and electrically connected to the bit line structure 380, and a vertical channel region extending upwardly in the first direction from one end of the horizontal channel region. A lower surface of the horizontal channel region may be in contact with the bit line structure 380, and the horizontal channel region may be electrically connected to the bit line structure 380.

The channel structure 405 may be formed of a semiconductor material such as silicon or the like, and may be formed of single crystal silicon or polysilicon, for example. The material constituting the channel structure 405 is not limited to a semiconductor material such as silicon or the like, and may be formed of another semiconductor material that may be used as a channel region of a transistor. For example, the channel structure 405 may include an oxide semiconductor layer or a two-dimensional material layer, which may be used as the channel region of the transistor.

The oxide semiconductor layer may be indium gallium zinc oxide (IGZO). Examples thereof are not limited thereto. For example, the oxide semiconductor layer may include at least one of indium tungsten oxide (IWO), indium tin gallium oxide (ITGO), indium aluminum zinc oxide (IAGO), indium gallium oxide (IGO), indium tin zinc oxide (ITZO), zinc tin oxide (ZTO), indium zinc oxide (IZO), ZnO, indium gallium silicon oxide (IGSO), indium oxide (InO), tin oxide (SnO), titanium oxide (TiO), zinc oxynitride (ZnON), magnesium zinc oxide (MgZnO), indium zinc oxide (InZnO), indium gallium zinc oxide (InGaZnO), zirconium indium zinc oxide (ZrInZnO), hafnium indium zinc oxide (HfInZnO), tin indium zinc oxide (SnInZnO), aluminum tin indium zinc oxide (AlSnInZnO), silicon indium zinc oxide (SiInZnO), zinc tin oxide (ZnSnO), aluminum zinc tin oxide (AlZnSnO), gallium zinc tin oxide (GaZnSnO), zirconium zinc tin oxide (ZrZnSnO), or indium gallium silicon oxide (InGaSiO).

The two-dimensional material layer may include at least one of a TMD material layer, a black phosphorous material layer, or a hexagonal Boron-Nitride material layer, having semiconductor properties. For example, the two-dimensional material layer may include at least one of BiOSe, Crl, WSe2, MoS2, TaS, WS, SnSe, ReS, β-SnTe, MnO, AsS, P(black), InSe, h-BN, GaSe, GaN, SrTiO, MXene, or Janus 2D materials, which may form a two-dimensional material.

The word line structure 410 may intersect the bit line structure 380 in a plan view. The word line structure 410 may extend in the third direction, and may be arranged in the second direction. The word line structure 410 may overlap the horizontal channel region of the channel structure 405 in the first direction, and may overlap the vertical channel region of the channel structure 405 in the second direction.

A word line dielectric layer 411 may be disposed between the word line structure 410 and the channel structure 405. The word line dielectric layer 411 may have a shape corresponding to the channel structure 405, but is not necessarily limited thereto. For example, the word line dielectric layer 411 may be a tunnel dielectric layer, and may include at least one of silicon oxide or a high-κ dielectric. According to one or more embodiments, the word line dielectric layer 411 may include a layer for storing information.

The upper insulating layer 403 may include a first upper insulating layer 401 and a second upper insulating layer 402, and the first upper insulating layer 401 may be formed along a surface of the bit line structure 380, a surface of the word line structure 410, a surface of the word line dielectric layer 411, and the like. The second upper insulating layer 402 may be disposed on the first upper insulating layer 401, and may fill a space between mold structures 409.

The upper capping layer 420 may cover the mold structure 409 and the upper insulating layer 403, and the landing pad 440 may penetrate a space formed in the upper capping layer 420. The landing pad 440 may penetrate the upper capping layer 420, and may be in contact with the channel structure 405. One side of the landing pad 440 may be in contact with the channel structure 405, and the other side of the landing pad 440 may be in contact with a first electrode 451 of the capacitor structure 450. The capacitor structure 450 may include a first electrode 451, a second electrode 452, and a capacitor dielectric layer 453 between the first electrode 451 and the second electrode 452.

In one or more embodiments, the method described above with reference to FIGS. 4 to 6 may be applied to a semiconductor device 200, to estimate a parameter affecting a difference in characteristics of the semiconductor device 200 manufactured from different wafers with high accuracy. For example, it is possible to determine which parameter affects a difference in characteristics between a memory cell included in a first wafer and a memory cell included in a second wafer, among a thickness of the channel structure 405, a doping concentration of the channel structure 405, a length of the word line structure 410, and a thickness of the word line dielectric layer 411.

In addition, it is also possible to determine an order in which the parameters including the thickness of the channel structure 405, the doping concentration of the channel structure 405, the length of the word line structure 410, and the thickness of the word line dielectric layer 411 greatly affect the difference in characteristics between the memory cell included in the first wafer and the memory cell included in the second wafer. Therefore, a parameter greatly affecting a difference in characteristics between memory cells according to a wafer may be determined, and a semiconductor process of forming the determined parameter may be monitored and controlled to reduce a characteristic deviation of the semiconductor device 200 according to the wafer and improve performance and yield of the semiconductor device 200, or the like.

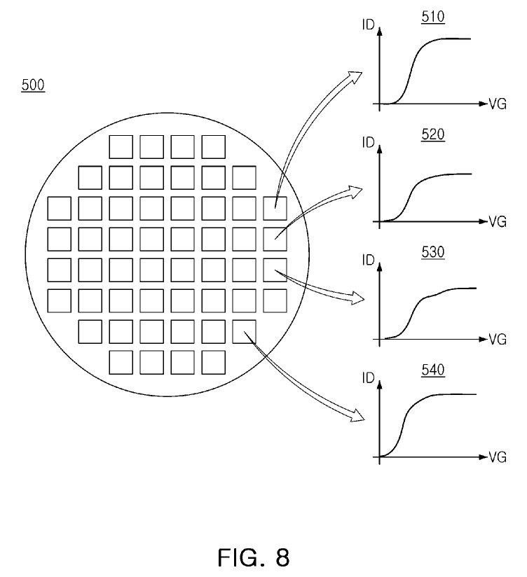

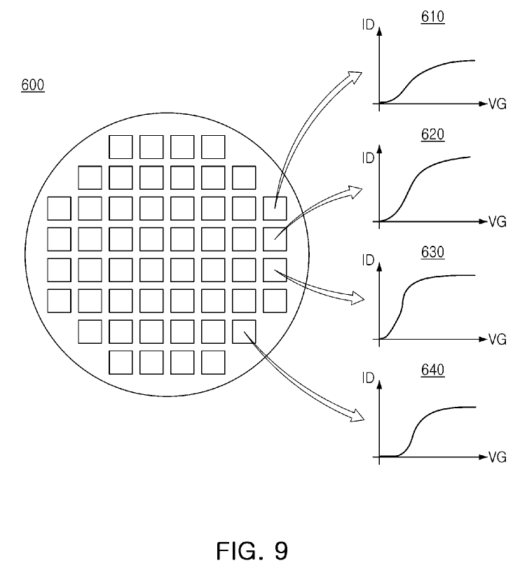

FIGS. 8 and 9 are views simply illustrating wafers to which a method for controlling a semiconductor process according to one or more embodiments is applied.

In one or more embodiments illustrated in FIGS. 8 and 9, the same semiconductor processes may be performed on a first wafer 500 and a second wafer 600. Therefore, a semiconductor device provided by a semiconductor die included in the first wafer 500 may be equal to a semiconductor device provided by a semiconductor die included in the second wafer 600. For example, the semiconductor die included in each of the first wafer 500 and the second wafer 600 may provide a DRAM device as described above with reference to FIG. 7.

First, referring to FIG. 8, a plurality of measured characteristic curves 510 to 540 may be generated from a plurality of semiconductor dies included in a first wafer 500. In one or more embodiments illustrated in FIG. 8, each of the plurality of measured characteristic curves 510 to 540 may be a gate voltage (VG)-drain current (ID) curve.

Next, referring to FIG. 9, a plurality of measured characteristic curves 610 to 640 may be generated from a plurality of semiconductor dies included in a second wafer 600. As described with reference to FIG. 8, each of the plurality of measured characteristic curves 610 to 640 generated from the second wafer 600 may be a gate voltage (VG)-drain current (ID) curve. For example, the gate voltage (VG)-drain current (ID) curves illustrated in FIGS. 8 and 9 may be a characteristic curve of a cell transistor including a word line structure and a channel structure in a DRAM device, as described with reference to FIG. 7.

The measured characteristic curves 510 to 540, and 610 to 640 may be generated by measurement equipment. When the first wafer 500 and the second wafer 600 are sequentially or simultaneously input into the measurement equipment, the measurement equipment may obtain the measured characteristic curves 510 to 540 from the plurality of semiconductor dies included in the first wafer 500, and may obtain the measured characteristic curves 610 to 640 from the plurality of semiconductor dies included in the second wafer 600. The measured characteristic curves 510 to 540, and 610 to 640 generated by the measurement equipment may be transmitted to control equipment.

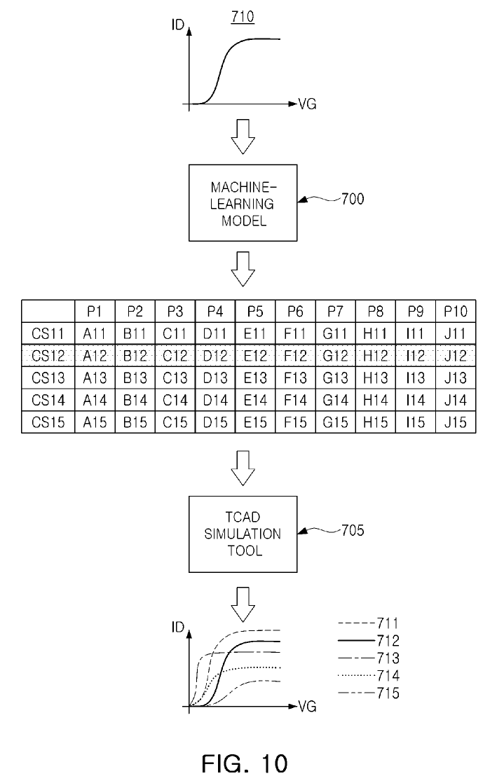

A memory of the control equipment may store a TCAD simulation tool, a machine-learning model receiving each of the measured characteristic curves 510 to 540, and 610 to 640 and estimating simulation parameters, which may be input variables of the TCAD simulation tool, a statistical analysis program, and the like. The control equipment may estimate which parameter among a plurality of simulation parameters causes a difference in characteristics between the first wafer 500 and the second wafer 600 by using the machine-learning model, the TCAD simulation tool, and the statistical analysis program. Hereinafter, an operation of the control equipment will be described in more detail with reference to FIGS. 10 to 13.

FIGS. 10 to 13 are views illustrating a method for controlling a semiconductor process according to one or more embodiments.

First, referring to FIG. 10, a first measured characteristic curve 710 generated from a first wafer may be input into a machine-learning model 700 stored in a memory of control equipment or the like. For example, the first measured characteristic curve 710 may represent a gate voltage (VG)-drain current (ID) characteristic of a first transistor included in the first wafer. The machine-learning model 700 may receive the first measured characteristic curve 710 to generate a plurality of candidate solutions CS11 to CS15.

Each of the plurality of candidate solutions CS11 to CS15 may include candidate values corresponding to a plurality of parameters P1 to P10. For example, in one or more embodiments illustrated in FIG. 10, a first candidate solution CS11 may include first to tenth candidate values A11 to J11 corresponding to first to tenth parameters P1 to P10. Similarly, a second candidate solution CS12 may include first to tenth candidate values A12 to J12 corresponding to the first to tenth parameters P1 to P10.

A task of predicting the plurality of parameters P1 to P10 from one first measured characteristic curve 710 of the machine-learning model 700 may include a multivariable function optimization task. Therefore, one first measured characteristic curve 710 may be input multiple times into the same machine-learning model 700, the machine-learning model 700 may output the plurality of different candidate solutions CS11 to CS15.

The control equipment may input each of the plurality of candidate solutions CS11 to CS15 into a TCAD simulation tool 705, to obtain a plurality of predicted characteristic curves 711 to 715 corresponding to the plurality of candidate solutions CS11 to CS15. The plurality of predicted characteristic curves 711 to 715 may be generated as gate voltage (VG)-drain current (ID) curves, similar to the first measured characteristic curve 710. Since the plurality of candidate solutions CS11 to CS15 may be generated differently, the plurality of prediction characteristic curves 711 to 715 may also be different from each other, as illustrated in FIG. 10.

The control equipment may compare each of the plurality of prediction characteristic curves 711 to 715 with the first actual measurement characteristic curve 710, and may determine one characteristic curve, most similar to the first actual measurement characteristic curve 710 as a selection characteristic curve, among the plurality of prediction characteristic curves 711 to 715. In one or more embodiments illustrated in FIG. 10, a second prediction characteristic curve 712 among the plurality of prediction characteristic curves 711 to 715 may have the lowest error rate compared to the first actual measurement characteristic curve 710, and thus the second prediction characteristic curve 712 may be selected as the selection characteristic curve.

The control equipment may select determination values for the plurality of parameters P1 to P10 using a candidate solution corresponding to a selection characteristic curve. The control equipment may determine the second candidate solution CS12 corresponding to the second prediction characteristic curve 712 as a selection solution, and may select determination values for the plurality of parameters P1 to P10 using the second candidate solution CS12. Therefore, in one or more embodiments illustrated in FIG. 10, the determination values for the plurality of parameters P1 to P10 may be determined as the candidate values A12 to J12 included in the second candidate solution C12.

The control equipment may also calculate an extraction deviation of each of the first to tenth parameters P1 to P10 using the plurality of candidate solutions CS11 to CS15. For example, the extraction deviation of the first parameter P1 may be determined as a standard deviation of the candidate values A11, A12, A13, A14, and A15 corresponding to the first parameter P1.

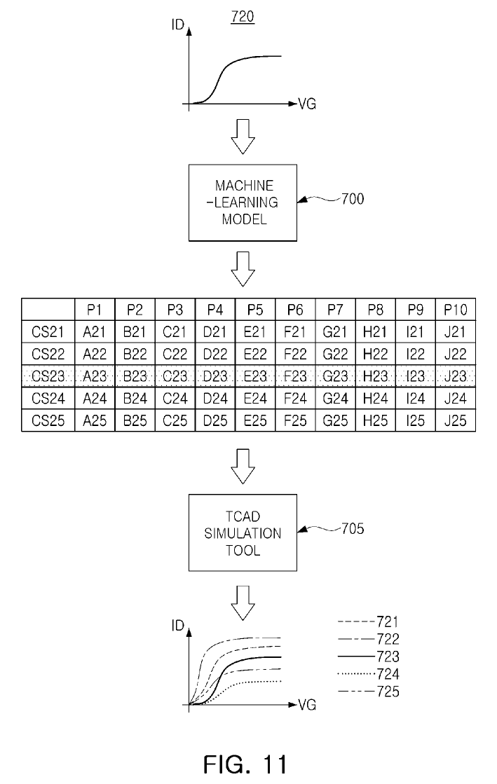

Next, referring to FIG. 11, a second measured characteristic curve 720 generated from a first wafer may be input into a machine-learning model 700 stored in a memory of control equipment or the like. The second measured characteristic curve 720 input into the machine-learning model 700 may represent a gate voltage (VG)-drain current (ID) characteristic of a second transistor included in the first wafer. The second transistor may be different from the first transistor.

The machine-learning model 700 may receive the second measured characteristic curve 720 multiple times, and the machine-learning model 700 may generate a plurality of candidate solutions CS21 to CS25. In a similar manner to those described with reference to FIG. 10, each of the plurality of candidate solutions CS21 to CS25 may include candidate values corresponding to the plurality of parameters P1 to P10. A first candidate solution CS21 may include first to tenth candidate values A21 to J21 corresponding to first to tenth parameters P1 to P10, and a second candidate solution CS22 may include first to tenth candidate values A22 to J22 corresponding to the first to tenth parameters P1 to P10.

The control equipment may input each of the plurality of candidate solutions CS21 to CS25 into a TCAD simulation tool to obtain a plurality of predicted characteristic curves 721 to 725. The plurality of predicted characteristic curves 721 to 725 may be generated as gate voltage (VG)-drain current (ID) curves, similar to the second measured characteristic curve 720.

The control equipment may compare each of the plurality of predicted characteristic curves 721 to 725 with the second measured characteristic curve 720, and may determine one characteristic curve, most similar to the second measured characteristic curve 720 as a selection characteristic curve, among the plurality of predicted characteristic curves 721 to 725. In one or more embodiments illustrated in FIG. 11, a third predicted characteristic curve 723 among the plurality of predicted characteristic curves 721 to 725 may have the lowest error rate compared to the second measured characteristic curve 720, and thus the third predicted characteristic curve 723 may be selected as the selection characteristic curve.

The control equipment may select determination values for the plurality of parameters P1 to P10 using a candidate solution corresponding to a selection characteristic curve. The control equipment may select candidate values A23 to J23 included in a third candidate solution CS23 corresponding to the third predicted characteristic curve 723 as the determination values for the plurality of parameters P1 to P10. As described above, the control equipment may also calculate an extraction deviation of each of the plurality of parameters P1 to P10 using the plurality of candidate solutions CS21 to CS25.

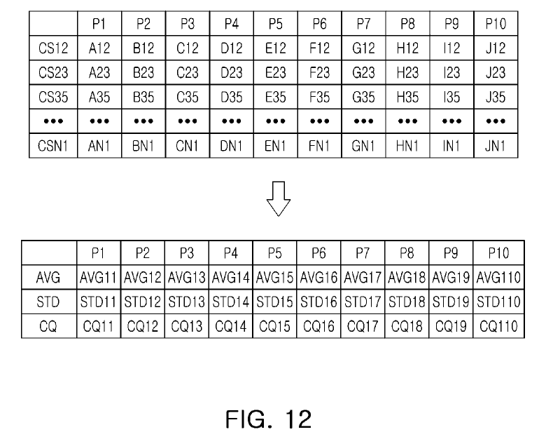

The control equipment may execute the operation described with reference to FIGS. 10 and 11 for each of N measured characteristic curves obtained from the first wafer, to generate raw data including a plurality of determination values for the plurality of parameters P1 to P10. FIG. 12 may represent raw data 800, which are illustrative.

Referring to FIG. 12, raw data 800 may include a plurality of determination values corresponding to a plurality of parameters P1 to P10. For example, as described above with reference to FIG. 10, determination values A12 to J12 corresponding to the plurality of parameters P1 to P10 may be generated using a first measured characteristic curve 710 obtained from a first transistor of a first wafer. In addition, as described above with reference to FIG. 11, determination values A23 to J23 corresponding to the plurality of parameters P1 to P10 may be generated using a second measured characteristic curve 720 obtained from a second transistor of a first wafer.

As described above, N determination values may be generated for each of the plurality of parameters P1 to P10 using N measured characteristic curves obtained from the first wafer. Referring to FIG. 12, N determination values A12, A23, A35 ... AN1 may be generated for a first parameter P1, N determination values B12, B23, B35 ... BN1 may be generated for a second parameter P2, and N determination values C12, C23, C35 ... CN1 may be generated for a third parameter P3. The raw data 800 may include N candidate solutions CS12, CS23, CS35 ... CSN1 generated for the plurality of parameters P1 to P10.

When the raw data 800 is generated, the control equipment may calculate an average AVG and a standard deviation STD with the selected determination values for each of the plurality of parameters P1 to P10. Referring to FIG. 12, a first average AVG11 and a first standard deviation STD11 may be calculated from N determination values A12, A23, A35 ... AN1 for a first parameter P1, and a second average AVG12 and a second standard deviation STD12 may be calculated from N determination values B12, B23, B35 ... BN1 for a second parameter P2. Similarly, a tenth average AVG110 and a tenth standard deviation STD110 may be calculated from N determination values J12, J23, J35 ... JN1 for a tenth parameter P10.

The control equipment may additionally calculate an extraction deviation CQ in addition to the average AVG and the standard deviation STD for each of the plurality of parameters P1 to P10. The extraction deviation CQ may be a numerical value that expresses the extent to which a multi-solution issue appears in each of the plurality of parameters P1 to P10. The control equipment may configure first statistical data 810 for the first wafer with the average AVG, the standard deviation STD, and the extraction deviation CQ, generated for each of the plurality of parameters P1 to P10.

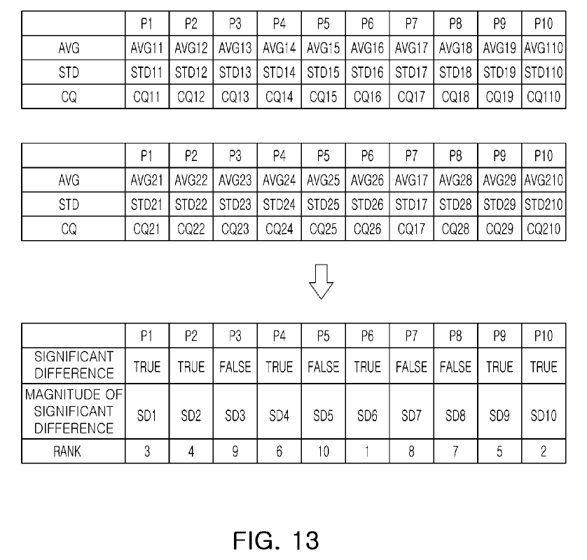

Referring to FIG. 13, control equipment may generate second statistical data 820 for a second wafer, different from a first wafer. For example, the control equipment may input each of measured characteristic curves, measured from transistors included in the second wafer into a machine-learning model multiple times to generate raw data for the second wafer, and may generate the second statistical data 820 using the raw data for the second wafer. The second statistical data 820 for the second wafer may include an average AVG, a standard deviation STD, an extraction deviation CQ, and the like, generated for a plurality of parameters P1 to P10.

The control equipment may determine whether a significant difference is absent or present and a magnitude of the significant difference for each of the plurality of parameters P1 to P10 by applying statistical analysis to first statistical data 810 for the first wafer and the second statistical data 820 for the second wafer. In one or more embodiments, the control equipment may input the first statistical data 810 and the second statistical data 820 into a statistical analysis program executing statistical analysis such as ANCOVA analysis, ANOVA analysis, or the like, to determine whether a significant difference is absent or present and a magnitude of the significant difference for each of the plurality of parameters P1 to P10.

For example, whether a significant difference is absent or present may mean whether a parameter corresponding thereto has a significant effect on a characteristic difference between the first wafer and the second wafer. The magnitude of significance difference may be produced relatively small for parameters in which the significance difference is determined as FALSE, and may be produced relatively large for parameters in which the significance difference is determined as TRUE. For example, the magnitude of the significance difference of a parameter in which the significance difference is determined as FALSE may be produced as 0 or as a value close to 0.

The control equipment may determine a rank RANK of each of the plurality of parameters P1 to P10, based on the absence or presence of a significance difference and a magnitude of the significance difference produced by applying statistical analysis. For example, as a magnitude of the significance difference calculated for each of the plurality of parameters P1 to P10 increases, a rank of the parameter corresponding thereto may be determined as a higher rank. In one or more embodiments illustrated in FIG. 13, a sixth parameter P6 may have the highest rank, and a fifth parameter P5 may have the lowest rank.

Therefore, the control equipment may determine that the sixth parameter P6 has the greatest influence on a difference in characteristics between the first wafer and the second wafer, and the fifth parameter P5 has the smallest influence. For example, assuming that the first wafer and the second wafer each include a DRAM device as described above with reference to FIG. 7, that the fifth parameter P5 may be a thickness of a gate insulating layer, and that the sixth parameter P6 may be a thickness of a channel structure formed of a material such as IGZO or the like, the control equipment may determine that a difference in characteristics between the first wafer and the second wafer is relatively greatly influenced by a difference in thickness of the channel structure. Therefore, the control equipment may reduce a difference in characteristics between the first wafer and the second wafer, and may improve yield of the process and reliability of the DRAM device by intensively monitoring a process of forming the channel structure and adjusting process variables of the process of forming the channel structure if necessary.

The extraction deviation CQ may also be applied to the statistical analysis described above. For example, as explained above, the extraction deviation CQ may be a numerical value that expresses the extent to which a plurality of resolution issues appear in each of the plurality of parameters P1 to P10. Therefore, the control equipment may determine that the significant difference of the parameters decreases, as the extraction deviation CQ increases, and may determine that the significant difference of the parameters increases, as the extraction deviation CQ decreases.

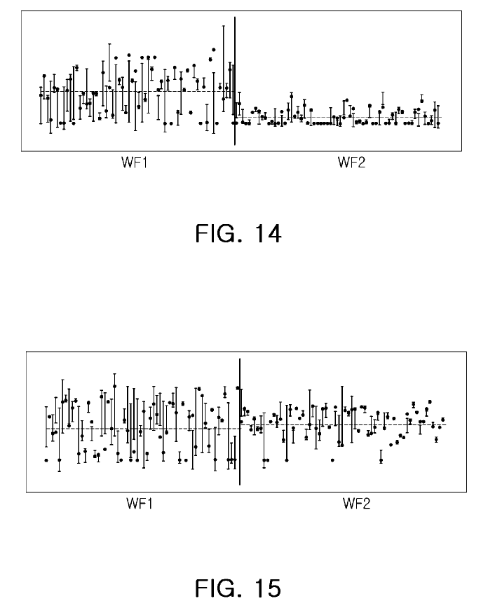

FIGS. 14 and 15 are views illustrating a method for controlling a semiconductor process according to one or more embodiments.

FIGS. 14 and 15 are views illustrating results from which a method for controlling a semiconductor process according to one or more embodiments is applied to a first wafer WF1 and a second wafer WF2, respectively. FIGS. 14 and 15 are views illustrating results for different parameters. For example, FIG. 14 may correspond to a first parameter having a relatively large significant difference, and FIG. 15 may correspond to a second parameter having a relatively small significant difference.

In each of FIGS. 14 and 15, a vertical line extending in a vertical direction may represent distribution of a plurality of candidate values obtained by inputting a measured characteristic curve measured from one element into a machine-learning model multiple times. As a length of the vertical line increases, distribution of candidate values obtained by inputting one measured characteristic curve into the machine-learning model multiple times may be widen.

In each of FIGS. 14 and 15, a horizontal axis may correspond to elements of which measured characteristic curves were measured in each of the first wafer WF1 and the second wafer WF2. For example, the vertical lines disposed at different positions in the horizontal direction in the first wafer WF1 may represent distribution of candidate values obtained by inputting measured characteristic curves, measured from different elements into the machine-learning model. A point matched to one vertical line in each of FIGS. 14 and 15 may be a determination value selected from a plurality of candidate values for a parameter corresponding thereto. Each of the measured characteristic curves measured for a plurality of elements included in the first wafer WF1 may be input into the machine-learning model, a plurality of candidate values may be generated for each of the plurality of elements. When one determination value is selected from the plurality of candidate values, a first average AVG1 and a first standard deviation may be produced using determination values for the plurality of elements. By repeating the operation for the second wafer WF2, a second average AVG2 and a second standard deviation may be produced.

Referring to FIGS. 14 and 15, a difference between the first average AVG1 and the second average AVG2 may be relatively large for a first parameter, and the difference between the first average AVG1 and the second average AVG2 may be relatively small for a second parameter. The first standard deviation, which represents dispersion of the determination values for the first wafer WF1, may be produced to be relatively smaller for the first parameter than for the second parameter. Similarly, the second standard deviation, which represents dispersion of the determination values for the second wafer WF2, may also be produced to be relatively smaller for the first parameter than for the second parameter.

The control equipment may determine whether a significant difference between the first parameter and the second parameter is absent or present, a relative magnitude of the significant difference, or the like with reference to results of comparison of the averages and the standard deviations. In one or more embodiments, the first parameter, which has a relatively large difference in average and a relatively small difference in standard deviation, which may be dispersion of determination values for each of the wafers WF1 and WF2, may have a larger significant difference than the second parameter. Therefore, the control equipment may interpret that influence of the first parameter on a difference in characteristics between the first wafer WF1 and the second wafer WF2 may be greater than influence of the second parameter on a difference in characteristics between the first wafer WF1 and the second wafer WF2. The control equipment may monitor a process related to the first parameter and, as necessary, may adjust process variables of the process related to the first parameter, thereby reducing a difference in characteristics between the wafers WF1 and WF2 and improving yield of the process or the like.

According to one or more embodiments, a measured characteristic curve measured from elements formed on each of different wafers may be input into a machine-learning model to obtain candidate values of simulation parameters, and among the candidate values, the measured characteristic curve in the candidate values may be compared to select determination values matching a characteristic curve having the lowest error rate. For the determination values selected from each of the wafers, an average and a standard deviation may be produced for each of the simulation parameters, and statistical analysis may be applied to the average and the standard deviation to determine a significant difference of each of the simulation parameters. Therefore, simulation parameters causing a change in characteristics of the wafer based on the significant difference may be determined, and a semiconductor process may be monitored and controlled, based thereon, to reduce the change in characteristics between the wafers, and improve manufacturing yield.

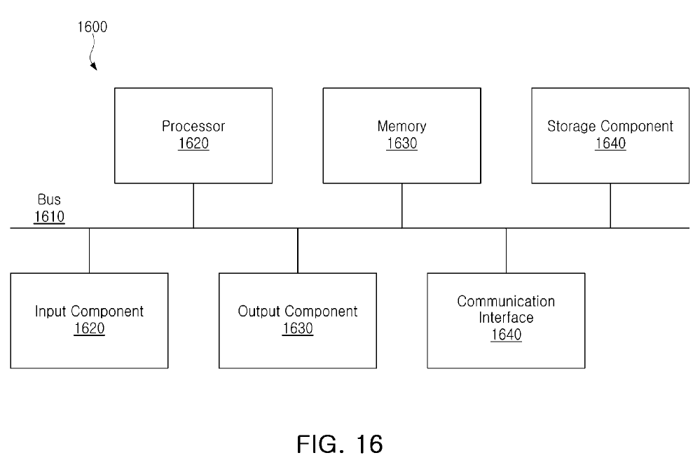

FIG. 16 is a block diagram of example components of a processor configured to perform any one of the above-disclosed methods. As shown in FIG. 16, the device 1600 may include a bus 1610, a processor 1620, a memory 1630, a storage component 1640, an input component 1650, an output component 1660, and a communication interface 1670.

The bus 1610 includes a component that permits communication among the components of the device 1600. The processor 1620 is implemented in hardware, firmware, or a combination of hardware and software. The processor 1620 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, the processor 1620 includes one or more processors capable of being programmed to perform a function. The memory 1630 includes a random access memory (RAM), a read only memory (ROM), and/or another type of dynamic or static storage device (e.g. a flash memory, a magnetic memory, and/or an optical memory) that stores information and/or instructions for use by the processor 1620.

The storage component 1640 stores information and/or software related to the operation and use of the device 1600. For example, the storage component 1640 may include a hard disk (e.g. a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

The input component 1650 includes a component that permits the device 1600 to receive information, such as via user input (e.g. a touch screen display, a keyboard, a keypad, a mouse, a button, a switch, and/or a microphone). Additionally, or alternatively, the input component 1650 may include a sensor for sensing information (e.g. a global positioning system (GPS) component, an accelerometer, a gyroscope, and/or an actuator). The output component 1660 includes a component that provides output information from the device 1600 (e.g. a display, a speaker, and/or one or more light-emitting diodes (LEDs)).

The communication interface 1670 includes a transceiver-like component (e.g., a transceiver and/or a separate receiver and transmitter) that enables the device 1600 to communicate with other devices, such as via a wired connection, a wireless connection, or a combination of wired and wireless connections. The communication interface 1670 may permit the device 1600 to receive information from another device and/or provide information to another device. For example, the communication interface 1670 may include an Ethernet interface, an optical interface, a coaxial interface, an infrared interface, a radio frequency (RF) interface, a universal serial bus (USB) interface, a Wi-Fi interface, a cellular network interface, or the like.

The device 1600 may perform one or more processes described herein. The device 1600 may perform these processes in response to the processor 1620 executing software instructions stored by a non-transitory computer-readable medium, such as the memory 1630 and/or the storage component 1640. A computer-readable medium is defined herein as a non-transitory memory device. A memory device includes memory space within a single physical storage device or memory space spread across multiple physical storage devices.

Software instructions may be read into the memory 1630 and/or the storage component 1640 from another computer-readable medium or from another device via the communication interface 1670. When executed, software instructions stored in the memory 1630 and/or the storage component 1640 may cause the processor 1620 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 16 are provided as an example. In practice, the device 1600 may include additional components, fewer components, different components, or differently arranged components than those shown in FIG. 16. Additionally, or alternatively, a set of components (e.g. one or more components) of the device 1600 may perform one or more functions described as being performed by another set of components of the device 1600.

Various advantages and effects of the present disclosure are not limited to the above-described contents, and will be more easily understood in the process of explaining specific embodiments.

While example embodiments have been illustrated and described above, it will be apparent to those skilled in the art that modifications and variations could be made without departing from the scope of the present disclosure as defined by the appended claims.

What is claimed is:

1. A method for controlling a semiconductor process, comprising:
obtaining a plurality of candidate values for a plurality simulation parameters of a plurality of first elements included in a first wafer and a plurality of second elements included in a second wafer by inputting a plurality of measured characteristic curves, measured from each of the plurality of first elements and each of the plurality of second elements, into a machine-learning model a plurality of times;
obtaining a plurality of predicted characteristic curves based on the plurality of candidate values for each of the plurality of first elements and each of the plurality of second elements;
determining a selection characteristic curve having a lowest error rate among the plurality of predicted characteristic curves by comparing the predicted plurality of characteristic curves with the plurality of measured characteristic curves;
selecting, among the plurality of candidate values, a candidate value matching the selection characteristic curve as a determination value for the plurality of simulation parameters;
calculating a first average and a first standard deviation with determination values selected for the plurality of first elements, and calculating a second average and a second standard deviation with determination values selected for the plurality of second elements; and
applying statistical analysis to the first average, the second average, the first standard deviation, and the second standard deviation, to determine a difference in the plurality of simulation parameters.

2. The method of claim 1, wherein, as a difference between the first average and the second average increases, it is determined that the difference in the plurality of simulation parameters increases.

3. The method of claim 2, wherein, as each of the first standard deviation and the second standard deviation decrease, it is determined that the difference in the plurality of simulation parameters increases.

4. The method of claim 1, wherein, as each of the first standard deviation and the second standard deviation increase, it is determined that the difference in the plurality of simulation parameters decreases.

5. The method of claim 1, wherein the obtaining the plurality of candidate values comprises inputting each of the plurality of measured characteristic curves into the machine-learning model a plurality of times, to obtain a plurality of candidate solutions including the plurality of candidate values for the plurality of simulation parameters, and
the obtaining the plurality of predicted characteristic curves comprises inputting the plurality of candidate solutions into a technology computer aided design (TCAD) simulation tool to obtain the plurality of predicted characteristic curves.

6. The method of claim 5, wherein a selection solution corresponding to the selection characteristic curve, among the plurality of candidate solutions, is determined for each of the plurality of first elements and each of the plurality of second elements,
wherein the first average and the first standard deviation of each of the plurality of simulation parameters are calculated using the selection solutions determined for the plurality of first elements, and
wherein the second average and the second standard deviation of each of the plurality of simulation parameters are calculated using the selection solutions determined for the plurality of second elements.

7. The method of claim 5, wherein the plurality of simulation parameters include a thickness of a gate insulating layer, a length of a gate, a doping concentration of a channel, and a thickness of the channel.

8. The method of claim 5, further including:
calculating an extraction deviation using the selection solutions for each of the plurality of simulation parameters, and
determining, based on the extraction deviation, whether the difference of each of the plurality of simulation parameters is determined, based on the extraction deviation.

9. The method of claim 5, wherein a rank corresponding to a relative ranking of the plurality of simulation parameters, is determined, and a process affecting at least one of the plurality of simulation parameters is monitored based on the rank.

10. The method of claim 1, wherein, based on determining the difference of the plurality of simulation parameters is greater than or equal to a reference value, a process affecting the plurality of simulation parameter is monitored.

11. A method for controlling a semiconductor process, comprising:
obtaining a plurality of first measured characteristic curves by inserting a first wafer into measurement equipment;
obtaining, by using the plurality of first measured characteristic curves, first raw data comprising a plurality of first solutions for simulation parameters, which are input variables of a technology computer aided design (TCAD) simulation tool;
obtaining a plurality of second measured characteristic curves by inserting a second wafer, different from the first wafer, into the measurement equipment;
obtaining, by using the plurality of second measured characteristic curves, second raw data including a plurality of second solutions for the simulation parameters, which are the input variables of the TCAD simulation tool;
generating first statistical data by calculating an average and a standard deviation for each of the simulation parameters from the first raw data;
generating second statistical data by calculating an average and a standard deviation for each of the simulation parameters from the second raw data; and
inputting the first statistical data and the second statistical data into a statistical analysis program to determine whether a difference of each of the simulation parameters is absent or present, and a magnitude of the difference.

12. The method of claim 11, further comprising:
determining a rank corresponding to a relative ranking of the simulation parameters based on the magnitude of the difference of each of the simulation parameters; and
monitoring, based on the rank, a process related to at least one of the simulation parameters.

13. The method of claim 12, further including:
adjusting, based on the rank, a process variable for controlling the process related to at least one of the simulation parameters.

14. The method of claim 11, wherein the statistical analysis program applies Analysis of Covariance (ANCOVA) analysis to the first statistical data and the second statistical data, to determine whether the difference of each of the simulation parameters is absent or present, and the magnitude of the difference.

15. The method of claim 11, wherein each of the plurality of first measured characteristic curves and each of the plurality of second measured characteristic curves comprises a gate voltage-drain current curve of a transistor.

16. The method of claim 11, wherein the statistical analysis program determines, for each of the simulation parameters, that the difference increases as a difference between the average included in the first statistical data and the average included in the second statistical data increases, and as each of the standard deviation included in the first statistical data and the standard deviation included in the second statistical data decrease.

17. A method for controlling a semiconductor process, comprising:
using a technology computer aided design (TCAD) simulation tool receiving a plurality of simulation parameters to output a predicted characteristic curve of an element, and a machine-learning model receiving a plurality of measured characteristic curves, measured from a wafer to predict the plurality of simulation parameters, to generate raw data including solutions for the plurality of simulation parameters;
calculating an average and a standard deviation for each of the simulation parameters based on the raw data to generate statistical data;
selecting at least one simulation parameter among the plurality of simulation parameters using the statistical data; and
monitoring a process related to the at least one simulation parameter.

18. The method of claim 17, further including:
inputting each of the plurality of measured characteristic curves into the machine-learning model a plurality of times, to obtain candidate solutions for the plurality of simulation parameters; and
determining a selection solution among the candidate solutions for each of the measured characteristic curves to generate the raw data.

19. The method of claim 17, wherein the generation of the raw data includes inputting first measured characteristic curves, measured from a first wafer into the machine-learning model, to generate first raw data, and inputting second measured characteristic curves, measured from a second wafer, different from the first wafer, into the machine-learning model, to generate second raw data, and
the generation of the statistical data includes generating first statistical data using the first raw data, and generating second statistical data using the second raw data.

20. The method of claim 19, wherein Analysis of Covariance (ANCOVA) analysis is applied to the first statistical data and the second statistical data to select the at least one simulation parameter from among the simulation parameters.
